(19) United States
(12) Patent Application Publication
(10) Pub. No.: US 2017/0208796 A1
(43) Pub. Date: Jul. 27, 2017

(54) A GLAZING

(71) Applicant: PILKINGTON GROUP LIMITED, LATHOM (GB)

(72) Inventors: NICOLA RUTH THOMPSON, RUFFORD (GB); SIMON JAMES HURST, RUNCORN (GB)

(73) Assignee: PILKINGTON GROUP LIMITED, LATHOM (GB)

(21) Appl. No.: 15/312,683

(22) PCT Filed: May 27, 2015
(86) PCT No.: PCT/GB2015/051540

§ 371 Date: Nov. 21, 2016

(30) Foreign Application Priority Data
May 28, 2014 (GB) 1409408.0

(51) Int. Cl. A01M 29/08; C03C 17/34

(52) U.S. Cl. CPC A01M 29/08; C03C 17/3417; C03C 2217/734; C03C 2218/34; C03C 2217/211; C03C 2217/212; C03C 2217/213; C03C 2217/241; C03C 2218/152

(57) ABSTRACT

A glazing for minimizing or preventing bird collisions with windows or other glazings, the glazing comprising at least one substrate, and at least one anti-reflective coating, wherein said coating is deposited directly, or indirectly, on the substrate in a patterned arrangement comprising a plurality of separate elements. In one embodiment, the elements comprise a plurality of stripes, in another a plurality of dots. Embodiments may comprise an additional coating, for example a UV reflectance coating.

The invention relates to a bird protection glazing. In particular, the invention relates to a bird protection glazing for buildings.

Bird deaths due to window strikes represent one of the greatest threats to avian mortality next to habitat destruction. Due to the reflective and transparent characteristics of glass, the glass is not perceived as a barrier to the bird. The bird does not recognize that reflections of, for example, the sky, other buildings, vegetation and even open space, are false. As a result, the bird flies into the glass. Typically, the glass is a glazing in a building, for example, a window, but could equally be a glass balcony, a glazed door, etc.

Many millions of birds die each year from collisions with glass on buildings. While songbirds are most at risk from collisions with glass, nearly 300 species have been reported as collision victims, including hummingbirds, woodpeckers, kingfishers, waders and birds of prey. It is likely that these numbers will grow as advances in glass technology and production make it possible to construct buildings with all-glass curtain walls, in addition to the general increase in the amount of glass being used in architecture.

The reduction of bird strikes can be achieved in a number of ways. A common approach involves creating a visual signal that alerts the birds to the presence of the window for example, it has been shown that the use of ultraviolet (UV) patterns on glass may help birds to detect the presence of the glass. One such product is known under the registered trade mark Ornilux Mikado®. This glass has a UV patterned coating which is visible to birds but substantially invisible to the human eye.

It is an object of the present invention to provide an improved glazing for minimising or preventing bird collisions with windows.

According to an aspect of the present invention there is provided a glazing for minimising or preventing bird collisions with windows or other glazings, the glazing comprising at least one substrate, and at least one antireflective coating, wherein said coating is deposited directly or indirectly on the substrate in a patterned arrangement comprising a plurality of separate elements.

Advantageously, provision of a plurality of antireflective elements on the glazing is more readily visible to a bird; the glazing appears to the bird as a pattern rather than simply a reflection of the surrounding area. For example, the reflection of the landscape appears to the bird as a broken up picture. Therefore, the risk of birds colliding with the glazing is minimised.

Preferably, the elements are equidistantly spaced apart.

Preferably, the patterned arrangement is a regular pattern, preferably having at least one line of symmetry. Preferably, the at least one line of symmetry is perpendicular to the longitudinal axis of the glazing.

Preferably, the elements comprise a plurality of stripes which are preferably located parallel to the longitudinal axis of the glazing. Preferably, the or each stripe is at least 1 cm in width. Preferably, each stripe is between 2 cm and 10 cm in width.

The elements may comprise a plurality of dots. Preferably, the or each dot has a radius of substantially greater than 1 mm. Preferably, the distance between the midpoint of neighbouring dots is substantially less than 15 cm, preferably less than 10 cm.

Preferably, the coating is deposited directly on to the substrate.

Preferably, the coating forms at least a part of an exposed surface of the glazing.

Preferably, at least one additional coating is provided on the glazing. Preferably, the at least one additional coating is provided adjacent the or each antireflective coating, in a side by side arrangement, preferably as a plurality of stripes or dots. Preferably the stripes are substantially less than 10 cm in width, preferably substantially being 2.5 cm in width.

The at least one additional coating is preferably a UV reflectance coating. Preferably, the UV reflectance coating comprises titanium dioxide, preferably having a geometric thickness of between substantially 10-100 nm, preferably between 10-50 nm, most preferably substantially 35 nm thickness.

Provision of UV elements, for example, stripes or dots alongside antireflective stripes or dots, provides a strong highly visible contrasting pattern visible to birds. The antireflective coating in combination with the patterned UV reflectance coating enhances bird visible UV reflected light in one area of the pattern while minimising broadband reflection (including bird-visible UV) in other areas to maximise the apparent contrast in bird vision. The effect of this is to produce a pattern that is highly visible to birds so allowing birds to avoid fatal collisions with buildings glazed with these coatings.

The reflectance of glass can be reduced by the application of appropriate thin film interference coatings—“Anti-Reflection coatings”. For a broad spectral response said coatings generally fall into 3 categories as follows:
1) Single layer coatings of porous low index materials such as porous silica—which give an intermediate effective refractive index between glass and air, so reducing the reflectance at the interfaces;
2) Three layer medium/high/low refractive index combinations. An example of such a combination is Glass/46 nm ZnSnOₓ/93 nm TiO₂/75 nm SiO₂;
3) Four layer high/low/high/low refractive index combinations such as the “Optiview” coating (nominally Glass/12 nm SnOₓ/25 nm SiO₂/110 nm SnOₓ/90 nm SiO₂).

All of said categories are considered to be equally valid for the purposes of the present invention, as are other variations based on the same principles.

Preferably, the antireflective coating comprises a plurality of layers. Preferably, said layers comprise a first layer comprising tin oxide (SnO₂). Preferably, the first layer, most preferably SnO₂, has a geometric thickness of between substantially 5 nm and 100 nm, preferably between 10 nm and 50 nm, preferably between 10 nm and 20 nm, most preferably substantially 12 nm.

Preferably, a second layer is provided preferably comprising silicon dioxide (SiO₂), preferably the SiO₂ has a geometric thickness of between substantially 5 nm and 100 nm, preferably between 10 nm and 50 nm, preferably between 15 nm and 30 nm, most preferably substantially 25 nm. Most preferably, the second layer is deposited over the first layer.

Preferably, a third layer is provided preferably comprising fluorine doped tin oxide (F:SnO₂) preferably the F:SnO₂ had a geometric thickness of between substantially 5 nm and 200 nm, preferably between 50 nm and 150 nm, preferably between 100 nm and 120 nm, most preferably substantially 110 nm. Most preferably, the third layer is deposited over the second layer.

Preferably, a fourth layer is provided preferably comprising SiO₂. Preferably, the SiO₂ has a geometric thickness of between substantially 5 nm and 200 nm, preferably between 50 nm and 150 nm, preferably between 80 nm and 100 nm, most preferably substantially 90 nm. Most preferably, the fourth layer is deposited over the third layer.

Preferably, each coating layer is deposited by chemical vapour deposition (CVD) or magnetron sputtering. Preferably, the patterned arrangement is achieved by shadow masking, preferably blanking off sections of a gas inlet distribution slot, and potentially the reactor face. Alternative routes for sputtering may include applying a masking tape and peeling said tape off to give a pattern; preferably masking using an ink; or preferably etching the pattern into the coating.

Preferably, the at least one substrate is a ply of glass, preferably a float or rolled glass. Preferably, the or each substrate of glass is a pane of extra clear glass (glass having greater than 85% visible light transmission (measured with Illuminant A) at thicknesses preferably from 2 to 20 mm, most preferably substantially 4 mm geometric thickness. The substrate may be a low-iron float glass, for example, having an iron content of 0.015% w/w or lower. The or each substrate may be a ply of tinted glass having a visible light transmission of less than 85%.

The invention is not limited to the substrate being a glazing in a building. For example, the substrate may be a door, a balcony, a spandrel.

The substrate may be manufactured from polymeric material.

Preferably, the substrate comprises a surface #1 and a surface #2. Surface #1 is that surface of the substrate which faces the exterior of a building when mounted in use. Preferably, at least one antireflective coating is provided on surface #1 of the substrate. A UV reflectance coating may further be provided on surface #1.

The antireflective coating may be provided on surface #2 of the substrate.

The glazing may comprise a further coating, preferably a solar control coating, preferably a low-E coating.

In a further aspect the invention provides an insulated glazing unit for minimising or preventing bird collisions with windows or other glazings, comprising a first sheet of glazing material, a second sheet of glazing material, and at least one antireflective coating, characterised in that the at least one antireflective coating is deposited directly or indirectly on the first and/or second sheet in a patterned arrangement, the patterned arrangement comprising a plurality of separate elements.

Preferably, at least one UV reflectance coating is provided on the unit. Preferably, said UV coating is provided adjacent the or each antireflective coating.

It will be understood by the skilled reader that the first sheet of glazing material has a first surface (surface #1) and an opposing second surface (surface #2), and the second sheet of glazing material has a third surface (surface #3) and an opposing fourth surface (surface #4). In use in a building glazing, surface #1 faces the exterior of a building and surface #4 faces the interior of a building.

Preferably, an antireflective coating is provided on surface #1. The or a further antireflective coating may be provided on surface #2 and/or surface #3 and/or surface #4.

Preferably, at least one solar control coating, or low E coating is provided on surface #2 and/or surface #3 and/or surface #4.

In a further aspect, the invention provides a use of a glazing or glazing unit as hereinbefore described, as an anti-collision bird safe glazing.

All of the features described herein may be combined with any one of the above aspects, in any combination.

An embodiment of the invention will now be described, by way of example only, with reference to the accompanying drawings, wherein:

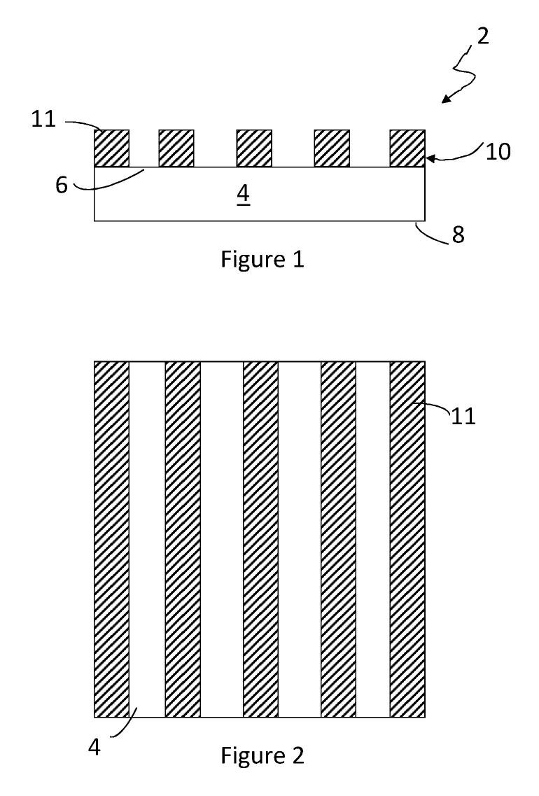

FIG. 1 shows a schematic side view of a glazing according to the invention;

FIG. 2 shows a schematic plan view of a glazing according to the invention;

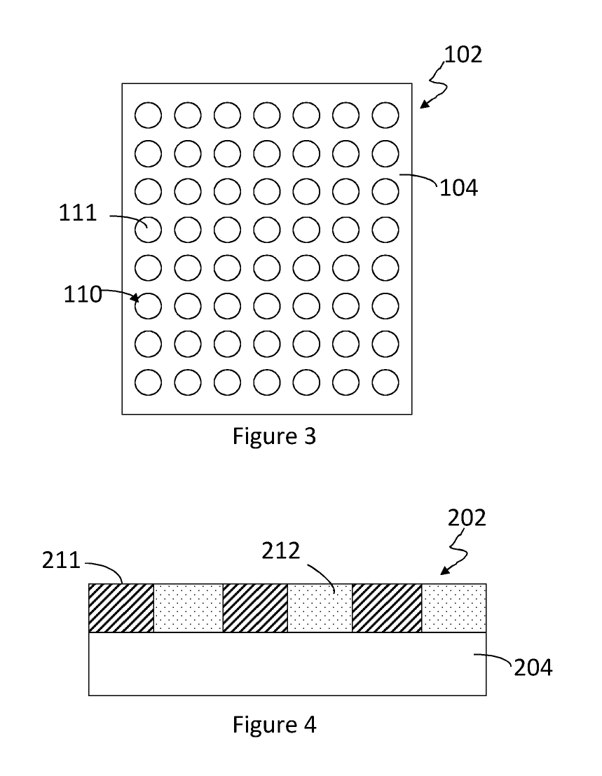

FIG. 3 shows a schematic plan view of an embodiment of a glazing according to the invention;

FIG. 4 shows a schematic side view of a further alternative embodiment of the invention;

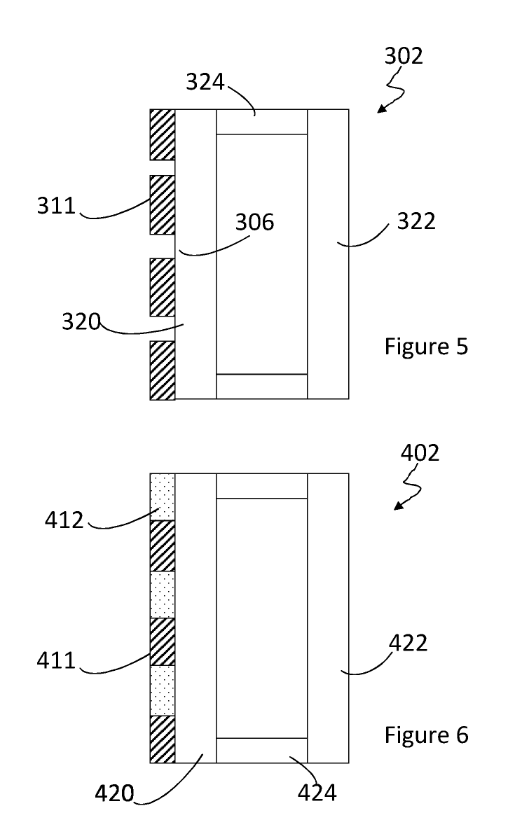

FIG. 5 shows a schematic side view of an insulated glazing unit according to the invention; and

FIG. 6 shows a schematic side view of an alternative embodiment of an insulated glazing unit according to the invention.

FIG. 1 shows a glazing 2 according to the invention. The glazing 2 is a monolithic glazing comprising a substrate 4 having a first surface 6 (surface #1) and a second surface 8 (surface #2). The first surface 6 is that surface of the glazing which faces the exterior of a building when in use.

An antireflective coating 10 is provided in a patterned arrangement of separate elements 11 on the glazing 2. Said coating 10 is deposited using chemical vapour deposition in the float bath region of a float furnace, a process as described in W097/42357A1 and hereby incorporated by reference. A shadow masking technique is used to achieve the required patterned arrangement whereby sections of the coater gas inlet distribution slot are blanked off to achieve a patterning.

FIG. 2 shows the elements in a striped arrangement. In this arrangement, it is preferred that each stripe 11 is substantially 7.5 cm in width, in a repeating pattern, having a line of symmetry perpendicular to the longitudinal axis of the glazing 2.

The antireflective coating 10 consists of a plurality of layers comprising: a first layer of SnO₂ having a geometric thickness of approximately 12 nm; a second layer of SiO₂ having a geometric thickness of approximately 25 nm deposited over the first layer; a third layer of SnO₂:F having a geometric thickness of approximately 110 nm deposited over the second layer; and a fourth layer of SiO₂ having a geometric thickness of approximately 90 nm deposited over the third layer.

FIG. 3 shows an alternative embodiment of a glazing 102 having a patterned arrangement of antireflective coating elements 111. In this arrangement, the coating 110 comprises a plurality of equidistantly spaced dots 111. The radius of preferably each dot is substantially greater than 1 mm. The distance between the mid-point of neighbouring dots 111 is preferably substantially less than 15 cm, preferably less than 10 cm.

FIG. 4 shows a further embodiment of a glazing 202. The glazing 202 comprises a plurality of antireflective coating elements 211 having adjacent UV reflectance coating stripes 212. Both coatings are shown deposited on surface #1 of a substrate 204. In this arrangement, a bird would see a highly visibly contrasting pattern and so would be deterred from flying into the glazing. It will be appreciated that the stripes 211 may be replaced with dots or a similar patterning configuration. The UV reflectance coating 212 comprises titanium oxide having a geometric thickness of approximately 31 nm. Deposition of the titanium oxide is by sputter coating using conditions in Table 1 below. Shadow masks made from thin glass cut to 75 mm width and attached with vacuum compatible adhesive tape are laid on the glass, preferably covering the antireflective patterning. The titania is then deposited on the glazing using pure Ti metal targets in plasma emission monitor-controlled oxygen reactive sputtering.

TABLE 1
TiO₂ deposition parameters

| Layer | Material | Process Parameters |
|---|---|---|
| 1 | Ti | 35 kW 100 kHz MF, Speed 466 mm/min (5 passes), |
| | | Ar 250 sccm, 13% PEM setpoint for Ti emission, |
| | | controlling O2 flow (giving 62-73 sccm) |

The invention is not limited to a monolithic glazing as shown in FIGS. 5 and 6. FIG. 5 shows an insulated glazed unit 302 having a first ply 320, a second ply 322 and a spacer 324 therebetween. An antireflective patterned coating comprising a number of elements 311 is provided on surface #1 (306) of the glazing unit 302.

FIG. 6 shows an alternative embodiment of an insulated glazing unit 402. The unit 402 has an antireflective patterned coating comprising elements 411 provided on surface #1. A UV reflectance coating 412 is provided adjacent each element 411 as shown in the figure. The coating 411, 412 may be provided on any of the surfaces of the unit 402.

Advantageously, an antireflective coating deposited in a patterned arrangement on a substrate, provides a contrasting pattern which a bird can recognise. When a UV reflectance coating is placed next to the antireflective coating, a highly contrasting patterning is achieved which acts as a further deterrent and helps birds to avoid flying into the window.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1.-18. (canceled)

19. A glazing for minimising or preventing bird collisions with windows or other glazings, the glazing comprising at least one substrate, and at least one antireflective coating, wherein said coating is deposited directly or indirectly on the substrate in a patterned arrangement comprising a plurality of separate elements.

20. The glazing as claimed in claim 19, wherein the patterned arrangement is a regular pattern.

21. The glazing as claimed in claim 19, wherein the patterned arrangement has at least one line of symmetry.

22. The glazing as claimed in claim 19, wherein the elements comprise a plurality of stripes.

23. The glazing as claimed in claim 22, wherein the stripes are located parallel to the longitudinal axis of the glazing.

24. The glazing as claimed in claim 22, wherein the or each stripe is at least 1 cm in width.

25. The glazing as claimed in claim 19, wherein the elements comprise a plurality of dots.

26. The glazing as claimed in claim 25, wherein the distance between the mid-point of neighbouring dots is substantially less than 15 cm.

27. The glazing as claimed in claim 19, wherein the coating is deposited directly on to the substrate.

28. The glazing as claimed in claim 19, wherein the coating forms at least a part of an exposed surface of the glazing.

29. The glazing as claimed in claim 19, wherein at least one additional coating is provided on the glazing.

30. The glazing as claimed in claim 29, wherein the at least one additional coating is provided adjacent the or each antireflective coating, in a side by side arrangement.

31. The glazing as claimed in claim 29, wherein the at least one additional coating is provided adjacent the or each antireflective coating, in a side by side arrangement, substantially less than 10 cm in width.

32. The glazing as claimed in claim 29, wherein the at least one additional coating is a UV reflectance coating.

33. The glazing as claimed in claim 32, wherein the UV reflectance coating comprises titanium dioxide.

34. The glazing as claimed in claim 33, wherein the UV reflectance coating has a geometric thickness of between substantially 10-100 nm.

35. The glazing as claimed in claim 19, wherein the antireflective coating comprises a plurality of layers, having a first layer comprising tin oxide (SnO2); a second layer comprising silicon dioxide (SiO2); a third layer comprising fluorine doped tin oxide (SnO2:F); and a fourth layer comprising SiO2.

36. The glazing as claimed in claim 19, wherein the substrate comprises a surface #1 and a surface #2, and at least one antireflective coating is provided on surface #1.

37. The glazing or glazing unit as claimed in claim 19, wherein the at least one substrate is a ply of float or rolled glass.

38. An insulated glazing unit for minimising or preventing bird collisions with windows or other glazings, comprising a first sheet of glazing material, a second sheet of glazing material, and at least one antireflective coating, characterised in that the at least one antireflective coating is deposited directly or indirectly on the first and/or second sheet in a patterned arrangement, the patterned arrangement comprising a plurality of separate elements.
